(19) United States
(12) Patent Application Publication
(10) Pub. No.: US 2020/0062229 A1
(43) Pub. Date: Feb. 27, 2020

(54) BRAKE DEVICE FOR VEHICLE

(71) Applicant: ADVICS CO., LTD., Kariya-shi, Aichi (JP)

(72) Inventor: Kei AMAMOTO, Kariya-shi (JP)

(73) Assignee: Advics Co., Ltd., Kariya-shi, Aichi (JP)

(21) Appl. No.: 16/344,641

(22) PCT Filed: Oct. 27, 2017
(86) PCT No.: PCT/JP2017/038832

§ 371 Date: Apr. 24, 2019

(30) Foreign Application Priority Data
Oct. 28, 2016 (JP) 2016-211882

(51) Int. Cl. B60T 8/76; B60W 10/188; B60T 8/1761; B60T 13/68

(52) U.S. Cl. CPC B60T 8/76; B60T 13/686; B60T 8/1761; B60W 10/188

(57) ABSTRACT

A brake device includes a second setting unit that sets a target wheel deceleration of at least one of the wheels to which a target wheel brake force; detection units that detect the actual wheel deceleration of the wheel to which the target wheel deceleration; a first calculation unit that calculates a vehicle deceleration difference which is the difference between the target vehicle deceleration and the actual vehicle deceleration; a second calculation unit which calculates a wheel deceleration difference which is the difference between the target wheel deceleration and the actual wheel deceleration; and a correction unit which corrects, on the basis of the vehicle deceleration difference and the wheel deceleration difference, the target wheel brake force corresponding to at least one of the wheels to which the target wheel brake force is set so that the vehicle deceleration difference becomes smaller.

### TECHNICAL FIELD

The present invention relates to a brake device for a vehicle.

### BACKGROUND ART

A brake device for a vehicle includes a brake force applying unit configured to apply a brake force to a wheel, a deceleration setting unit configured to set a target vehicle deceleration, which is a target deceleration of the vehicle, in accordance with a brake operation, a brake force setting unit configured to set a target wheel brake force, which is a target brake force of a wheel, in accordance with the target vehicle deceleration, and a control unit configured to control the brake force applying unit on the basis of the target wheel brake force, for example. With the brake device for a vehicle, a distribution of the brake force (or the deceleration) of each wheel is determined depending on a state of the vehicle such as turning, for example. The distribution is disclosed in JP-A-2008-114642, for example.

### CITATION LIST

### Patent Literature

PTL 1: JP-A-2008-114642

### SUMMARY OF INVENTION

### Technical Problem

With the brake device for a vehicle of the related art, it is possible to perceive an actual deceleration of the vehicle and to control a target value (brake force or deceleration) relating to the vehicle. However, a state of each wheel is not perceived, so that there is a room for improvement on accuracy of the brake control. With the brake device for a vehicle of the related art, when a structural variation occurs between the respective wheels, for example, the target value relating to the vehicle is controlled without perceiving the variation, so that it is not perceived whether the distribution has been actually achieved.

The present invention has been made in view of the above situations, and an object thereof is to provide a brake device for a vehicle capable of perceiving states of wheels to improve accuracy of brake control.

### Solution to Problem

The brake device for a vehicle according to the present invention is a brake device for a vehicle including a brake force applying unit configured to apply a brake force to at least one of wheels of the vehicle; a first setting unit configured to set a target wheel brake force, which is a target brake force, to the at least one of wheels; a control unit configured to control the brake force applying unit on the basis of the target wheel brake force; a second setting unit configured to set a target wheel deceleration, which is a target deceleration, to the at least one of wheels to which the target wheel brake force is set; a detection unit configured to detect an actual wheel deceleration, which is an actual deceleration of the wheel to which the target wheel deceleration is set; a first calculation unit configured to calculate a vehicle deceleration difference, which is an absolute value of a difference between a target vehicle deceleration, which is a target deceleration of the vehicle, and an actual vehicle deceleration, which is an actual deceleration of the vehicle; a second calculation unit configured to calculate a wheel deceleration difference, which is an absolute value of a difference between the target wheel deceleration and the actual wheel deceleration, for the wheel to which the target wheel deceleration is set, and a correction unit configured to correct, on the basis of the vehicle deceleration difference and the wheel deceleration difference, the target wheel brake force corresponding to the at least one of wheels to which the target wheel brake force is set so that the vehicle deceleration difference is to be smaller.

### Advantageous Effects of Invention

According to the present invention, the wheel deceleration difference is perceived to perceive whether the target deceleration of the wheel has been achieved and a level of the difference between the target value and the actual value, i.e., a state (a target achievement state) of the wheel. Also, the target wheel brake force of at least one of wheels is corrected, based on the vehicle deceleration difference and the wheel deceleration difference, so that the brake force can be controlled in accordance with the state of the wheel. That is, according to the present invention, the state of the wheel is perceived to absorb variation in the vehicle state and to improve accuracy of the brake control, for example.

### BRIEF DESCRIPTION OF DRAWINGS

FIG. 1 is a diagram depicting a configuration of a brake device for a vehicle according to an exemplary embodiment.

FIG. 2 is a view depicting a structure of the brake device for a vehicle according to the exemplary embodiment.

FIG. 3 illustrates a brake force distribution setting line.

FIG. 4 is a flowchart for illustrating an example of a flow of brake control according to the exemplary embodiment.

FIG. 5 is a flowchart for illustrating an example of the flow of brake control according to the exemplary embodiment.

### DESCRIPTION OF EMBODIMENTS

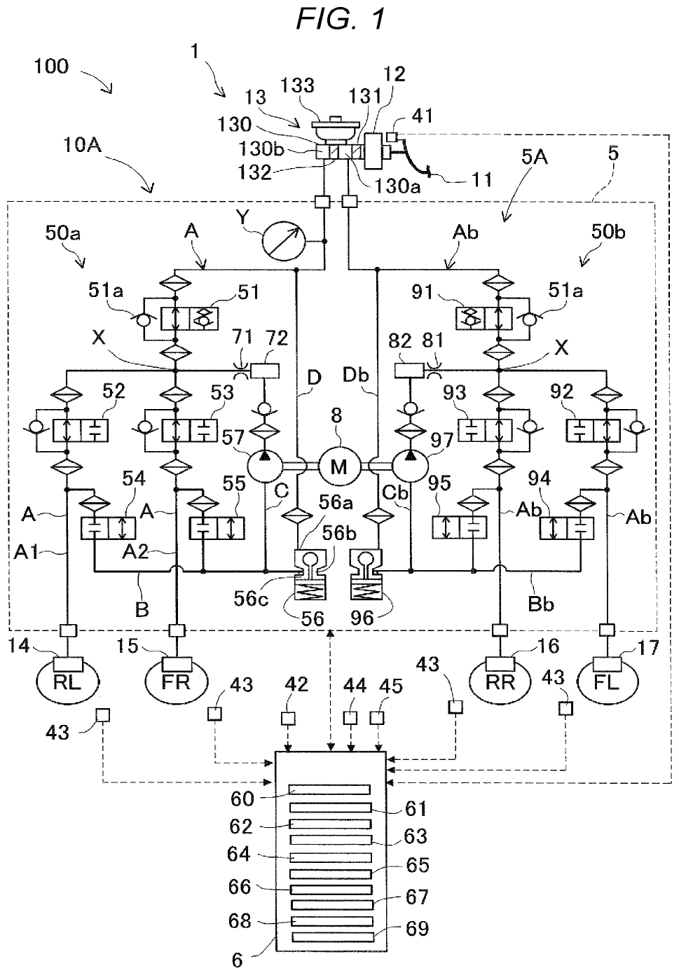

Hereinafter, an exemplary embodiment of the present invention will be described with reference to the drawings. Also, the respective drawings to be used for the descriptions are conceptual views, and shapes of respective parts are not always exact in some cases. As shown in FIG. 1, a brake device 100 for a vehicle of a first exemplary embodiment includes a fluid pressure generation unit 1, a stroke sensor 41, an acceleration sensor 42, wheel speed sensors 43, a steering angle sensor 44, a yaw rate sensor 45, an actuator 5, and a brake ECU 6.

The fluid pressure generation unit 1 includes a brake operating member 11, a booster device 12, a cylinder mechanism 13, and wheel cylinders 14, 15, 16, and 17. In the exemplary embodiment, the wheel cylinders 14 to 17 (or the fluid pressure generation unit 1) and the actuator 5 configure a brake force applying unit 10A configured to apply a brake force to a plurality of wheels FR, FL, RR, RL of the vehicle. In the exemplary embodiment, the brake operating member 11 is a brake pedal. The booster device 12 is a well-known device configured to boost a depression force, which is to be applied to the brake operating member 11 by a driver, and to transmit the same to the cylinder mechanism 13. As the booster device 12, for example, a negative pressure type, a fluid pressure type (for example, a type by an electromagnetic valve and a high pressure source), or an electric type (for example, a type where a motor is used) may be used. The booster device 12 can be referred to as a master piston drive unit configured to drive master pistons 131 and 132 in accordance with a brake operation.

The cylinder mechanism 13 includes a master cylinder 130, master pistons 131 and 132, and a reservoir 133. The master cylinder 130 is a cylindrical bottomed cylinder member. The brake operating member 11 is arranged at an opening-side of the master cylinder 130. In the below, for convenience of description, a bottom surface-side of the master cylinder 130 is referred to as the front and an opening-side is referred to as the rear. The master pistons 131 and 132 are slidably arranged in the master cylinder 130. The master piston 132 is arranged in front of the master piston 131. The master pistons 131 and 132 are configured to demarcate an inside of the master cylinder 130 into a first master chamber 130a and a second master chamber 130b. The first master chamber 130a is formed by the master pistons 131 and 132 and the master cylinder 130, and the second master chamber 130b is formed by the master piston 132 and the master cylinder 130. The reservoir 133 is a reservoir tank and is arranged to communicate with the first master chamber 130a and the second master chamber 130b by a flow passage. The reservoir 133 and each of the master chambers 130a and 130b are configured to communicate with each other and to be cut off in accordance of movements of the master pistons 131 and 132.

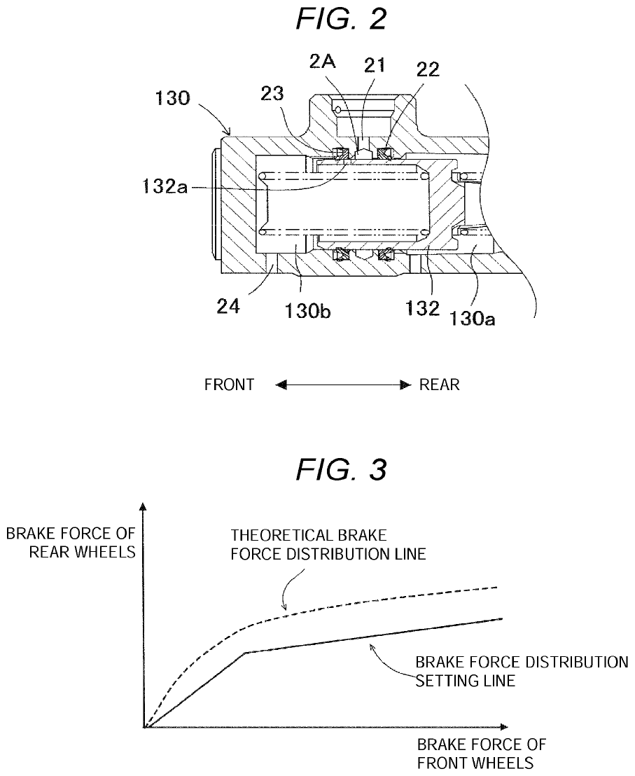

Specifically, a periphery of the second master chamber 130b is described. As shown in FIG. 2, the master cylinder 130 has a connection port 21 connected to the reservoir 133, seal members 22 and 23 and a connection port 24 connected to the actuator 5. The connection port 21 is a port for allowing the reservoir 133 and the second master chamber 130b to communicate with each other. The connection port 21 is arranged between the seal members 22 and 23. A cylindrical part of the master piston 132 is formed with a passage 132a for allowing an outer periphery-side and an inner periphery-side thereof to communicate with each other.

When the master piston 132 is located at an initial position (a state where the brake operating member 11 is not operated), the reservoir 133 and the second master chamber 130b communicate with each other through a flow passage 2A. The flow passage 2A is configured by the connection port 21, an inner peripheral surface of the master cylinder 130, an outer peripheral surface of the master piston 132, and the passage 132a. In the meantime, when the master piston 132 is advanced and the passage 132a is thus moved ahead of the seal member 23, the reservoir 133 and the second master chamber 130b are cut off by the seal member 23. That is, the flow passage 2A of a brake fluid between the reservoir 133 and the second master chamber 130b is configured to be cut off in association with the advancing of the master piston 132. By adjusting a movement amount of the master piston 132 until the flow passage 2A is to be cut off, it is possible to adjust an amount of an idle stroke that is a stroke interval in which an occurrence of fluid pressures of the master chambers 130a and 130b (hereinafter, referred to as “masterpressure”) is suppressed. The connection port 24 is a port for connecting the second master chamber 130b and the actuator 5, and is formed in front of the seal member 23 of the master cylinder 130. The first master chamber 130a is also provided with a connection port and a seal member, like the periphery of the second master chamber 130b, although a description thereof is omitted.

The wheel cylinder 14 is arranged at the wheel RL (left rear wheel). The wheel cylinder 15 is arranged at the wheel FR (right front wheel). The wheel cylinder 16 is arranged at the wheel RR (right rear wheel). The wheel cylinder 17 is arranged at the wheel FL (left front wheel). The master cylinder 130 and the wheel cylinders 14 to 17 are connected through the actuator 5. The wheel cylinders 14 to 17 are respectively configured to apply a brake force to the wheels RL to FR, in accordance with an input fluid pressure.

In this way, when the driver depresses the brake operating member 11, the depression force is boosted by the booster device 12, so that the master pistons 131 and 132 in the master cylinder 130 are pressed. When the master cylinder 130 and the reservoir 133 are cutoff (hereinafter, this state is referred to as “cutoff state”) as the master pistons 131 and 132 are advanced, the same master pressure is generated in the first master chamber 130a and the second master chamber 130b. The fluid pressure generation unit 1 generates the master pressure, which conforms to volumes of the first master chamber 130a and the second master chamber 130b in the cutoff state, in the first master chamber 130a and the second master chamber 130b of which volumes are changed in accordance with movements of the master pistons 131 and 132. The master pressure is reflected to the wheel cylinders 14 to 17 through the actuator 5. Also, although not shown, the fluid pressure generation unit 1 is provided with a reactive force spring for generating a reactive force to an operation of the brake operating member 11 until at least the master chambers 130a and 130b become in the cutoff state. Also, the fluid pressure generation unit 1 may include a stroke simulator configured to generate a reactive force to a stroke.

The stroke sensor 41 is a sensor configured to detect a stroke (an operating amount) of the brake operating member 11. The stroke sensor 41 is configured to transmit a detection result to the brake ECU 6. The acceleration sensor (deceleration detection unit) 42 is a sensor configured to detect an acceleration (deceleration) in a front and rear direction of the vehicle. The wheel speed sensors 43 are sensors configured to detect the rotating speeds of the respective wheels FR to RL, and are provided for the respective wheels FR to RL. The steering angle sensor 44 is a sensor configured to detect a steered angle by which a steering wheel (not shown) is operated. The yaw rate sensor 45 is a sensor configured to detect a yaw rate of the vehicle.

The actuator 5 is a device (a fluid pressure adjusting device) configured to adjust fluid pressures (hereinafter, referred to as “wheel pressures”) of the wheel cylinders 14 to 17, in accordance with an instruction from the brake ECU 6. Specifically, as shown in FIG. 1, the actuator 5 includes a hydraulic circuit 5A and a motor 8. The hydraulic circuit 5A includes a first piping system 50a and a second piping system 50b. The first piping system 50a is a system configured to control the fluid pressures (wheel pressures) to be applied to the wheels RL, FR. The second piping system 50b is a system configured to control the fluid pressures (wheel pressures) to be applied to the wheels FL, RR. That is, for the piping of the brake device 100 for a vehicle, an X piping type is adopted. Also, an H piping type may be adopted.

The first piping system 50a includes a main flow passage A, a differential pressure control valve 51, pressure increasing valves 52 and 53, a pressure decreasing flow passage B, pressure decreasing valves 54 and 55, a pressure adjusting reservoir 56, a reflux flow passage C, a pump 57, an auxiliary flow passage D, an orifice part 71, and a damper part 72. The flow passage may be referred to as a pipe line or a fluid pressure line, too, for example.

The main flow passage A is a flow passage for connecting the connection port 24 and the wheel cylinders 14 and 15. The differential pressure control valve 51 is an electromagnetic valve provided to the main flow passage A and configured to control the main flow passage A between a communication state and a differential pressure state. The differential pressure state can also be referred to as a throttle state in which a flow passage is restricted by a valve. The differential pressure control valve 51 is configured to control a differential pressure (hereinafter, also referred to as “first differential pressure”) between the fluid pressure on the master cylinder 130-side and the fluid pressure on the wheel cylinders 14, 15-side, regarding it as a center, in accordance with a control current based on an instruction from the brake ECU 6. In other words, the differential pressure control valve 51 is configured to control a differential pressure between the fluid pressure of the master cylinder 130-side of the main flow passage A and the fluid pressures of the wheel cylinders 14, 15-side of the main flow passage A.

The differential pressure control valve 51 is a normally opening type that is in the communication state under non-energization state. The higher the control current to be applied to the differential pressure control valve 51 is, the higher the first differential pressure is. When the differential pressure control valve 51 is controlled to the differential pressure state and the pump 57 is thus driven, the fluid pressures of the wheel cylinders 14, 15-side become higher than the fluid pressure of the master cylinder 130-side.

The differential pressure control valve 51 is provided with a check valve 51a. The brake ECU 6 can control the throttle state of the differential pressure control valve 51 by the control current. The main flow passage A is bifurcated into two flow passages A1, A2 at a bifurcation point X located downstream of the differential pressure control valve 51 so as to correspond to the wheel cylinders 14 and 15.

The pressure increasing valves 52 and 53 are electromagnetic valves configured to be opened and closed according to an instruction from the brake ECU 6 and are normally opening type electromagnetic valves that are in an opened state (communication state) under non-energization state. The pressure increasing valve 52 is arranged in the flow passage A1, and the pressure increasing valve 53 is arranged in the flow passage A2. The pressure increasing valves 52 and 53 are configured to be in an opened state under non-energization state and to thereby allow the wheel cylinders 14 and 15 and the bifurcation point X to communicate with each other upon pressure increasing control, and to be in a closed state under energization state and to thereby cut off the wheel cylinders 14 and 15 and the bifurcation point X upon holding control and pressure decreasing control. Also, the pressure increasing valves 52 and 53 may be electromagnetic valves configured to switch between the communication state and the differential pressure state on the basis of an instruction from the brake ECU 6, like the differential pressure control valve 51.

The pressure decreasing flow passage B is a flow passage for connecting a part between the pressure increasing valve 52 and the wheel cylinder 14 in the flow passage A1 and the pressure adjusting reservoir 56 and connecting a part between the pressure increasing valve 53 and the wheel cylinder 15 in the flow passage A2 and the pressure adjusting reservoir 56. The pressure increasing valves 52 and 53 are controlled to the closed state upon the pressure decreasing control and cuts off the master cylinder 130 and the wheel cylinders 14 and 15, for example.

The pressure decreasing valves 54 and 55 are electromagnetic valves configured to be opened and closed according to an instruction from the brake ECU 6 and are normally closing type electromagnetic valves that are in the closed state (cutoff state) under non-energization state. The pressure decreasing valve 54 is arranged in the pressure decreasing flow passage B of the wheel cylinder 14-side. The pressure decreasing valve 55 is arranged in the pressure decreasing flow passage B of the wheel cylinder 15-side. The pressure decreasing valves 54 and 55 are mainly energized and opened upon the pressure decreasing control, thereby allowing the wheel cylinders 14 and 15 and the pressure adjusting reservoir 56 to communicate with each other through the pressure decreasing flow passage B. The pressure adjusting reservoir 56 is a reservoir having a cylinder, a piston and an urging member.

The reflux flow passage C is a flow passage for connecting the pressure decreasing flow passage B (or the pressure adjusting reservoir 56) and a part (here, the bifurcation point X) between the differential pressure control valve 51 and the pressure increasing valves 52 and 53 in the main flow passage A. The pump 57 is provided to the reflux flow passage C so that a discharge port is arranged at the bifurcation point X-side and a suction port is arranged at the pressure adjusting reservoir 56-side. The pump 57 is a piston type electric pump that is to be driven by the motor 8. The pump 57 is configured to allow the brake fluid to flow from the pressure adjusting reservoir 56 toward the master cylinder 130-side or the wheel cylinders 14, 15-side through the reflux flow passage C.

The pump 57 is configured to repeat a discharge process of discharging the brake fluid and a suction process of sucking the brake fluid. That is, when the pump 57 is driven by the motor 8, the discharge process and the suction process are alternately repeatedly executed. In the discharge process, the brake fluid sucked from the pressure adjusting reservoir 56 in the suction process is supplied to the bifurcation point X. The motor 8 is configured to be energized and driven through a relay (not shown) according to an instruction from the brake ECU 6. The pump 57 and the motor 8 may be collectively referred to as an electric pump. Also, the pump 57 may be driven all the time while the vehicle is activated.

The orifice part 71 is a throttle-shaped part (so-called orifice) provided between the pump 57 in the reflux flow passage C and the bifurcation point X. The damper part 72 is a damper (damper mechanism) connected between the pump 57 in the reflux flow passage C and the orifice part 71. The damper part 72 is configured to absorb and discharge the brake fluid, in accordance with a pulsation of the brake fluid in the reflux flow passage C. The orifice part 71 and the damper part 72 may be referred to as a pulsation reducing mechanism configured to reduce (attenuate, absorb) the pulsation.

The auxiliary flow passage D is a flow passage for connecting a pressure adjusting hole 56a of the pressure adjusting reservoir 56 and a more upstream side (or the master cylinder 130) than the differential pressure control valve 51 in the main flow passage A. The pressure adjusting reservoir 56 is configured so that a valve hole 56b is to be closed as an inflow amount of the brake fluid to the pressure adjusting hole 56a increases as a result of a stroke increase. A side of the valve hole 56b facing toward the flow passages B, C is formed with a reservoir chamber 56c.

As the pump 57 is driven, the brake fluid in the pressure adjusting reservoir 56 or the master cylinder 130 is discharged to a part (bifurcation point X) between the differential pressure control valve 51 and the pressure increasing valves 52 and 53 in the main flow passage A through the reflux flow passage C. The wheel pressures are pressurized depending on control states of the differential pressure control valve 51 and the pressure increasing valves 52 and 53. In this way, the pressurization control is executed in the actuator 5 by the drive of the pump 57 and the controls of the diverse valves. That is, the actuator 5 is configured to pressurize the wheel pressures. Also, a part between the differential pressure control valve 51 and the master cylinder 130 in the main flow passage A is provided with a pressure sensor Y configured to detect a fluid pressure (master pressure) of the part. The pressure sensor Y is configured to transmit a detection result to the brake ECU 6.

The second piping system 50b is a system having the same configuration as the first piping system 50a and configured to adjust the fluid pressures of the wheel cylinders 16, 17. The second piping system 50b includes a main flow passage Ab corresponding to the main flow passage A, a differential pressure control valve 91 corresponding to the differential pressure control valve 51, pressure increasing valves 92, 93 corresponding to the pressure increasing valves 52 and 53, a pressure decreasing flow passage Bb corresponding to the pressure decreasing flow passage B, pressure decreasing valves 94, 95 corresponding to the pressure decreasing valves 54 and 55, a pressure adjusting reservoir 96 corresponding to the pressure adjusting reservoir 56, a reflux flow passage Cb corresponding to the reflux flow passage C, a pump 97 corresponding to the pump 57, an auxiliary flow passage Db corresponding to the auxiliary flow passage D, an orifice part 81 corresponding to the orifice part 71, and a damper part 82 corresponding to the damper part 72. The descriptions of the detained configurations of the second piping system 50b are omitted because the descriptions of the first piping system 50a can be referred to.

A pressure adjustment of the wheel pressure by the actuator 5 is made by executing the pressure increasing control of providing the master pressure to the wheel cylinders 14 to 17, the holding control of sealing the wheel cylinders 14 to 17, the pressure decreasing control of enabling the fluid in the wheel cylinders 14 to 17 to flow out toward the pressure adjusting reservoir 56 or the pressurization control of pressurizing the wheel pressure through the throttle by the differential pressure control valve 51 and the drive of the pump 57. The pressure increasing control, the holding control, the pressure decreasing control, and the pressurization control by the actuator 5 can be independently performed for each of the wheel cylinders 14 to 17.

The brake ECU 6 is an electronic control unit including a CPU, a memory and the like. The brake ECU 6 is configured to receive detection results (detection values) from a variety of sensors such as the stroke sensor 41, the acceleration sensor 42, the wheel speed sensors 43, the steering angle sensor 44, the yaw rate sensor 45 and the pressure sensor Y, and to control the actuation of the actuator 5 on the basis of the received information. The brake ECU 6 is configured to control the actuation of the actuator 5, thereby executing the pressure increasing control, the holding control, the pressure decreasing control or the pressurization control for each of the wheel cylinders 14 to 17. For the actuator 5, the brake ECU 6 is configured to execute an automatic pressurization control (for example, a side slip prevention control and a regenerative cooperation control) and an antiskid control (ABS control).

(Correction Control)

The brake ECU 6 has a calculation unit 60, a vehicle deceleration setting unit 61, a state determination unit 62, a distribution setting unit 63, a first setting unit 64, a control unit 65, a second setting unit 66, a first calculation unit 67, a second calculation unit 68, and a correction unit 69, as functions.

The calculation unit 60 is configured to calculate a vehicle speed, decelerations of the respective wheels FR to RL, and the like, as actual values, on the basis of the received information from the diverse sensors. Specifically, the calculation unit 60 is configured to calculate an actual wheel deceleration, which is an actual deceleration (acceleration) of each of the wheels FR to RL, a vehicle speed of the vehicle, a slip ratio of each of the wheels FR to RL, and the like, on the basis of the detection results of the wheel speed sensors 43. The actual wheel deceleration of each of the wheels FR to RL can be calculated on the basis of a speed of each of the wheels FR to RL calculated from a rotating speed of each of the wheels FR to RL, for example. The vehicle speed can be calculated from the rotating speeds of all the wheels FR to RL, for example. The slip ratio of each of the wheels FR to RL can be calculated from the vehicle speed and the speed of each of the wheels FR to RL, for example. Also, the calculation unit 60 may be configured to calculate an actual vehicle deceleration, which is an actual deceleration of the vehicle, based on the calculated vehicle speed. Also, the calculation unit 60 may be configured to acquire information of the actual vehicle deceleration from the acceleration sensor 42. The calculation unit 60 and the wheel speed sensors 43 correspond to the “detection unit”.

The vehicle deceleration setting unit 61 is configured to set a target vehicle deceleration that is a target deceleration of the vehicle. Specifically, the vehicle deceleration setting unit 61 is configured to set the target vehicle deceleration (which can also be referred to as ‘requested deceleration’), depending on situations, for example, on the basis of a request of the driver, i.e., the detection result (stroke) of the stroke sensor 41.

The state determination unit 62 is configured to determine states of the vehicle (for example, a turning state of the vehicle, a traveling road state, the number of passengers, a loaded weight and the like) on the basis of the detection results of the diverse sensors. Specifically, the state determination unit 62 is configured to determine a turning state of the vehicle on the basis of the detection result of the steering angle sensor 44 and/or the yaw rate sensor 45 (operation behavior detection sensors). The turning state can be indicated, for example, by whether the vehicle is turning, and a turning direction and a degree of turning when the vehicle is turning. Also, the state determination unit 62 is configured to determine a traveling road state on the basis of the detection result of the acceleration sensor 42 and the vehicle speed calculated by the calculation unit 60. The determination of the traveling road state is to determine whether the vehicle is located on an ascending road of a predetermined slope or higher, a descending road of a predetermined slope or higher or the other normal road. The turning state and the traveling road state may be determined by the well-known method.

The distribution setting unit 63 is configured to set a distribution (for example, a distribution ratio) of the brake force to be applied to each of the wheels FR to RL, based on the target vehicle deceleration and the determination result of the state determination unit 62. When it is determined by the state determination unit 62 that the vehicle is traveling in a straight line on a normal road (a road of which a slope is within a predetermined range), for example, the distribution setting unit 63 sets the distribution so that the brake force of the rear wheels RR, RL is to be smaller than the brake force of the front wheels FR, FL, so as to prevent the rear wheels RR, RL from being locked earlier than the front wheels FR, FL, in accordance with a brake force distribution setting line (refer to FIG. 3) preset on the basis of a theoretical brake force distribution line. A distribution example of the distribution setting unit 63 will be described later. The distribution setting unit 63 has a function of an electronic control brake force distribution system (EBD).

The first setting unit 64 is configured to set a target wheel brake force that is a target brake force of each of the wheels FR to RL. Specifically, in the exemplary embodiment, the first setting unit 64 is configured to set the target wheel brake force that is a target brake force of each of the wheels FR to RL, based on the target vehicle deceleration set by the vehicle deceleration setting unit 61 and the distribution set by the distribution setting unit 63. Also, the first setting unit 64 may be configured to set a target brake force (which can also be referred to as ‘requested brake force’) that is a target brake force of the vehicle corresponding to the target vehicle deceleration, so as to achieve the target vehicle deceleration, for example. In this case, the first setting unit 64 is configured to set the target wheel brake force of each of the wheels FR to RL, based on the target brake force and the distribution.

The control unit 65 is configured to control the actuator 5 (brake force applying unit 10A), based on the target wheel brake forces set by the first setting unit 64. The control unit 65 is configured to set a target wheel pressure that is a wheel pressure corresponding to the target wheel brake force, for each of the wheels FR to RL (each of the wheel cylinders 14 to 17). The control unit 65 is configured to calculate an estimated wheel pressure that is an estimated value of a current wheel pressure, based on a detection value (master pressure) of the pressure sensor Y and a control state of the actuator 5. The control unit 65 is configured to execute the control on the actuator 5 (the pressure increasing control, the holding control, the pressure decreasing control or the pressurization control) so that the estimated wheel pressure is to approximate to the target wheel pressure, for each of the wheels FR to RL.

The second setting unit 66 is configured to set (calculate) a target wheel deceleration that is a target deceleration for one wheel or two or more wheels of the wheels FR to RL to which the target wheel brake force is set, based on the target wheel brake forces set by the first setting unit 64. In the exemplary embodiment, the second setting unit 66 is configured to set the target wheel deceleration for all of the wheels FR to RL. The target wheel deceleration can be calculated on the basis of Newton's equation of motion (F=ma), for example. In this case, for each of the wheels FR to RL, ‘F’ is a target wheel brake force, ‘m’ is a vertical load, and ‘a’ is a target wheel deceleration. The vertical load of each of the wheels FR to RL may be a preset setting value (for example, a value based on a weight distribution) or may be a calculation value to be calculated depending on the state of the vehicle. In the exemplary embodiment, the second setting unit 66 is configured to calculate (estimate) the vertical load of each of the wheels FR to RL, based on the determination result of the state determination unit 62. For example, the vertical loads of the front wheels FR, FL become larger than the vertical loads of the rear wheels RR, RL during the traveling on the descending road, upon sudden braking and the like, for example.

The first calculation unit 67 is configured to acquire information of the actual vehicle deceleration, which is the actual deceleration (acceleration) of the vehicle, from the acceleration sensor 42 (or the calculation unit 60). The first calculation unit 67 is configured to calculate a vehicle deceleration difference that is an absolute value of a difference between the target vehicle deceleration and the actual vehicle deceleration. The second calculation unit 68 is configured to acquire information of the actual wheel deceleration of each of the wheels FR to RL from the calculation unit 60. The second calculation unit 68 is configured to calculate a wheel deceleration difference, which is an absolute value of a difference between the target wheel deceleration and the actual wheel deceleration, for each of the wheels FR to RL.

The correction unit 69 is configured to correct the target wheel brake force corresponding to at least one of the wheels FR to RL to which the target wheel deceleration is set so that the vehicle deceleration difference is to be smaller, based on the vehicle deceleration difference calculated by the first calculation unit 67 and the wheel deceleration difference calculated by the second calculation unit 68. The target wheel brake force after the correction is referred to as ‘corrected wheel brake force’. The correction unit 69 is configured to determine the wheels FR to RL to be corrected (which are referred to as ‘correction target wheel’) on the basis of the wheel deceleration difference, and to correct the target wheel brake force of the correction target wheel so that the vehicle deceleration difference is to be smaller. That is, the correction unit 69 is configured to set the corrected wheel brake force, which is obtained by correcting the target wheel brake force, to the correction target wheel. The correction unit 69 is configured to set the corrected wheel brake force to one or more wheels FR to RL, depending on situations.

The corrected wheel brake force is a value obtained by adding or subtracting any correction amount to or from the target wheel brake force of the correction target wheel (corrected wheel brake force=the target wheel brake force ±the correction amount). For example, when the actual vehicle deceleration is smaller than the target vehicle deceleration, the correction unit 69 adds a correction amount (a calculated value or a predetermined value) to the target wheel brake force of the correction target wheel so that the actual vehicle deceleration is to approximate to the target vehicle deceleration. The correction unit 69 sets the larger correction amount when the wheel deceleration difference of the correction target wheel is larger, for example.

The correction unit 69 is configured to determine the wheel FR to RL, which has a largest wheel deceleration difference, of the wheels FR to RL, as the correction target wheel, for example. The correction unit 69 is configured to set the correction amount of each of the wheels FR to RL so that the correction amount of the wheel FR to RL having the largest wheel deceleration difference is to be larger than the correction amounts (including zero) of the wheels FR to RL having a relatively small wheel deceleration difference, for example. Also, the correction amount of 0 means that there is no correction. Also, the correction unit 69 is configured to further determine the correction target wheel, based on the determination result of the state determination unit 62. An example of the correction by the correction unit 69 will be described later.

Also, in the exemplary embodiment, the correction unit 69 is configured to store the correction amount of the target wheel brake force corresponding to the correction target wheel, and to correct the target wheel brake force corresponding to the correction target wheel on the basis of the stored correction amount, in a next brake operation and thereafter. According to this configuration, even when a regular variation occurs, it is possible to set the target wheel brake force, in a next brake operation and thereafter, considering the variation. The correction unit 69 is configured to store the correction target wheel and the correction amount thereof, and to correct the target wheel brake force of the correction target wheel by a correction amount smaller than the stored correction amount in a next brake operation after the first storing, for example. When the similar storing is made a predetermined number of times or larger, the correction unit may correct the target wheel brake force of the correction target wheel by an amount equivalent to the stored correction amount, from a next brake operation.

When a corrected wheel brake force is set by the correction unit 69, the control unit 65 controls the actuator 5, based on the corrected wheel brake force. That is, the control unit 65 is configured to execute the fluid pressure control for the wheels FR to RL to which the corrected wheel brake force is set, based on the corrected wheel brake force (target wheel pressure after correction), and to execute the fluid pressure control for the wheels FR to RL to which the corrected wheel brake force is not set, based on the target wheel brake force (target wheel pressure). Also, the correction unit 69 may be set not to execute the correction when the vehicle deceleration difference is within a predetermined allowable range (a predetermined value or smaller).

Like this, the brake device 100 for a vehicle according to the exemplary embodiment is a brake device for a vehicle including a brake force applying unit 10A configured to apply a brake force to at least one of the wheels FR to RL (i.e., one or more wheels) of the vehicle; a first setting unit 64 configured to set a target wheel brake force, which is a target brake force, to the at least one of wheels FR to RL (i.e., the wheel to which the brake force is to be applied); a control unit 65 configured to control the brake force applying unit 10A on the basis of the target wheel brake force; a second setting unit 66 configured to set a target wheel deceleration, which is a target deceleration, to the at least one of the wheels FR to RL to which the target wheel brake force is set; detection units 43, 60 configured to detect an actual wheel deceleration, which is an actual deceleration of the wheel FR to RL to which the target wheel deceleration is set; a first calculation unit 67 configured to calculate a vehicle deceleration difference, which is an absolute value of a difference between a target vehicle deceleration, which is a target deceleration of the vehicle, and an actual vehicle deceleration, which is an actual deceleration of the vehicle; a second calculation unit 68 configured to calculate a wheel deceleration difference, which is an absolute value of a difference between the target wheel deceleration and the actual wheel deceleration, for the wheels FR to RL to which the target wheel deceleration is set, and a correction unit 69 configured to correct, on the basis of the vehicle deceleration difference and the wheel deceleration difference, the target wheel brake force corresponding to the at least one of the wheels FR to RL to which the target wheel brake force is set so that the vehicle deceleration difference is to be smaller.

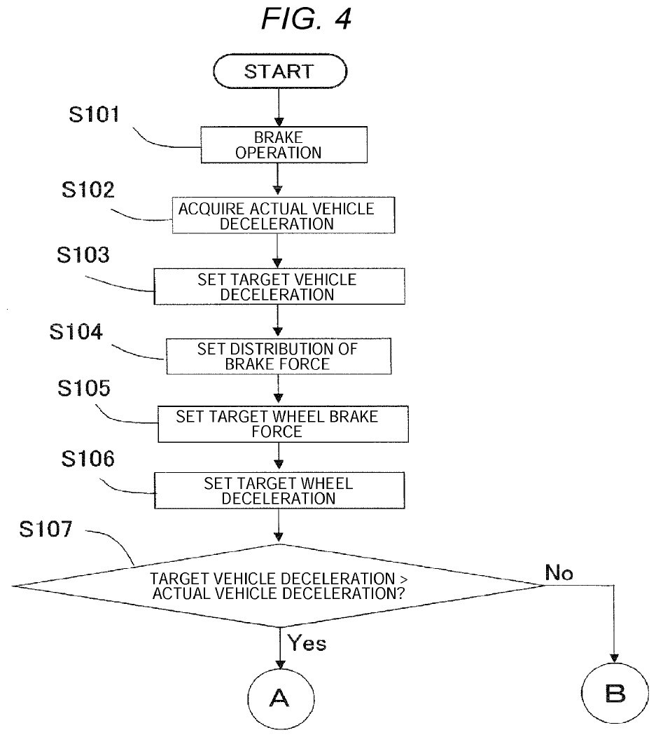

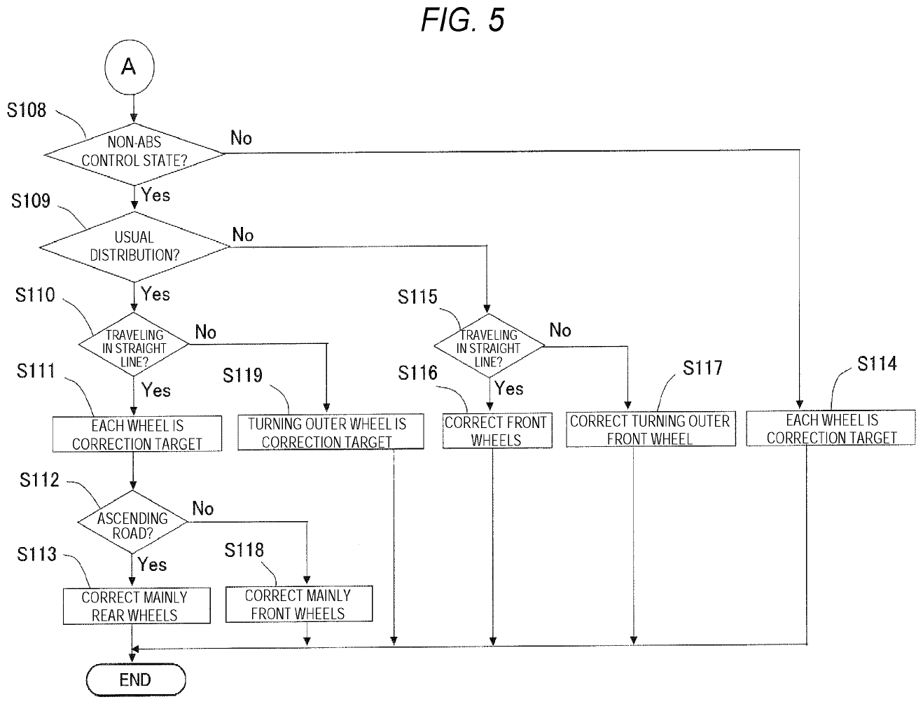

Here, an example of a flow of the brake control according to the exemplary embodiment is described with reference to FIGS. 4 and 5. As shown in FIG. 4, when the driver performs the brake operation (S101), the brake ECU 6 acquires actual vehicle deceleration information from the acceleration sensor 42 (S102), and sets the target vehicle deceleration in accordance with the detection result (stroke) of the stroke sensor 41 (S103). Then, the distribution setting unit 63 sets a distribution (a distribution ratio) of the brake force to be applied to each of the wheels FR to RL, based on the determination result of the state determination unit 62 (S104). The first setting unit 64 sets the target wheel brake force to be applied to each of the wheels FR to RL, based on the set target vehicle deceleration and distribution (S105). The second setting unit 66 sets the target wheel deceleration for each of the wheels FR to RL, based on the target wheel brake force of each of the wheels FR to RL (S106).

The brake ECU 6 determines whether the target vehicle deceleration is larger than the actual vehicle deceleration, i.e., whether the actual vehicle deceleration is insufficient (S107). When the actual vehicle deceleration is insufficient (S107: Yes), the brake ECU 6 determines whether it is a non-ABS control state (S108), as shown in FIG. 5. When it is a non-ABS control state (S108: Yes), the brake ECU 6 determines whether the brake force distribution is a usual distribution, i.e., a non-EBD distribution (S109). When a usual distribution is performed (S109: Yes), the state determination unit 62 determines whether the vehicle is traveling in a straight line (S110). When the vehicle is traveling in a straight line (S110: Yes), the correction unit 69 corrects the target wheel brake force of each of the wheels FR to RL, based on the wheel deceleration difference in each of the wheels FR to RL (Sill).

That is, when the brake operation is performed during the straight traveling of the vehicle in a state where the ABS control is not performed and a distribution equivalent to the EBD is not made, the correction unit 69 sets the corrected wheel brake force for each of the wheels FR to RL so that the wheel deceleration difference is to be smaller in each of the wheels FR to RL. In this example, since the target vehicle deceleration is not achieved, the correction unit 69 corrects the target wheel brake force so that the brake force is to increase. The brake ECU 6 corrects the target wheel pressure toward the increase side so that the wheel deceleration difference of each of the wheels FR to RL is to be smaller, and enables the actuator 5 to execute the pressurization control.

According to the exemplary embodiment, in a situation where any special control (for example, ABS or EBD) is not performed and the vehicle is traveling in a straight line, the correction is executed so that the wheel deceleration difference of each of the wheels FR to RL is to be smaller. Here, in a situation where any special control (for example, ABS or EBD) is not performed and the vehicle is turning (S110: No), the correction unit 69 sets a turning outer wheel as a correction target, and corrects the target wheel brake force of the turning outer wheel toward the increase side, based on the wheel deceleration difference (S114). That is, the correction unit 69 determines the correction target wheel, based on arrangement of the wheels with respect to the turning direction of the vehicle.

Subsequently, the state determination unit 62 determines whether the vehicle is located on the ascending or descending road (S112). In this determination, when the vehicle is traveling on the ascending road, the determination result is Yes, when the vehicle is traveling on the descending road, the determination result is No, and otherwise, the determination result is END. When the vehicle is located on the ascending road (S112: Yes), the correction unit 69 corrects the target wheel brake force of the rear wheels RR, RL toward the increase side, and corrects the target wheel brake force of the front wheels FR, FL toward the decrease side, if necessary, based on the vehicle deceleration difference (S113). While the vehicle is traveling on the ascending road, since the vertical loads of the rear wheels RR, RL increase, the increase in the brake force of the rear wheels RR, RL can contribute to the vehicle stability. Therefore, the correction unit 69 corrects the target wheel brake force of the rear wheels RR, RL toward the increase side so that the vehicle deceleration difference is to be smaller. On the other hand, when the vehicle is located on the descending road (S112: No), the correction unit 69 corrects the target wheel brake force of the front wheels FR, FL toward the increase side, and corrects the target wheel brake force of the rear wheels RR, RL toward the decrease side, if necessary, based on the vehicle deceleration difference (S115). This correction is performed due to the same reason as the case where the vehicle is located on the ascending road.

Also, when the ABS control is executed (S108: No), the correction unit 69 adds the correction amount to the target wheel brake force of each of the wheels FR to RL so that the wheel deceleration difference of each of the wheels FR to RL is to be smaller (S116). That is, the correction unit 69 sets the corrected wheel brake force higher than the target wheel brake force to each of the wheels FR to RL, based on the wheel deceleration difference (S116). Also, when a distribution setting equivalent to the EBD is made (S109: No) and the vehicle is traveling in a straight line (S117: Yes), the correction unit corrects the target wheel brake force of the front wheels FR, FL toward the increase side, based on the wheel deceleration difference (S118). When the brake force distribution is performed by the EBD (for example, the brake operation is performed with the high depression force) and the target vehicle deceleration is not achieved, it can be estimated that the distribution of FIG. 3 is not implemented. Therefore, the correction unit 69 corrects the target wheel brake force of the front wheels FR, FL toward the increase side, from a standpoint of the vehicle stability. By this correction, a braking point (a point at which the gradient changes) of FIG. 3 may not be implemented.

On the other hand, when a distribution setting equivalent to the EBD is made (S109: No) and the vehicle is turning (S117: No), the correction unit corrects the target wheel brake force of the turning outer front wheel toward the increase side, based on the wheel deceleration difference, from the standpoint of the vehicle stability (S119). The turning outer front wheel is the left front wheel FL when the vehicle is turning in a clockwise direction, for example.

Also, when the target vehicle deceleration is equal to or smaller than the actual vehicle deceleration (S107: No), the brake ECU 6 performs following control (B), for example. When the target vehicle deceleration is equal to the actual vehicle deceleration (including a slight difference), the correction unit 69 does not execute the above-described correction control. Also, when the target vehicle deceleration is smaller than the actual vehicle deceleration, i.e., the deceleration is excessive, the correction unit 69 determines the correction target wheel, based on the wheel deceleration difference and the distribution, from the above standpoint of safety, and corrects the target wheel brake force of the correction target wheel toward the decrease side.

According to the exemplary embodiment, the wheel deceleration difference of each of the wheels FR to RL is perceived to perceive whether the target deceleration of each of the wheels FR to RL has been achieved and a level of the difference between the target value and the actual value, i.e., a state (a target achievement state) of the wheel. Also, the target wheel brake force of at least one of the wheels FR to RL is corrected on the basis of the vehicle deceleration difference so that the vehicle deceleration difference is to be smaller. Thereby, it is possible to perform the brake force control, in accordance with the actual states of the wheels FR to RL.

For example, the brake ECU of the related art cannot perceive whether the desired fluid pressure brake force is actually output, even though it perceives, for controlling, that the fluid pressure conforming to the target wheel pressure is supplied to the corresponding wheel cylinder. For example, a plurality of wheel cylinders to which the same fluid pressure is supplied may exhibit different brake forces, due to variations of elements required to exhibit the brake force, such as variation (for example, variation in coefficient of friction) of a brake pad, a state of tire, a loaded state, a hydraulic pressure, and an environment. In the variation state, when the actual vehicle deceleration does not reach the target vehicle deceleration, the brake ECU of the related art cannot perceive the variation, so that it is necessary to bring the actual vehicle deceleration into close to the target vehicle deceleration by increasing the target wheel pressures of all the wheels. According to this configuration, a state where a brake force difference has occurred due to the variation is kept between the wheels, so that the vehicle may be pulled toward the wheel having the higher brake force.

In contrast, according to the exemplary embodiment, it is possible to specify the wheel of which deceleration is insufficient (or excessive), and to perform the brake force correction, which contributes to the vehicle stability, on the basis of the specifying. That is, it is possible to absorb the variation and to achieve the desired deceleration distribution by setting the corrected wheel brake force to the appropriate wheels FR to RL. Also, since it is possible to perceive the state of the wheel without depending on the slip ratio, it is possible to appropriately perform the correction, even before a slip occurs. In this way, according to the exemplary embodiment, the states of the wheels FR to RL are perceived on the basis of the wheel deceleration difference, so that it is possible to improve the accuracy of the brake control.

Also, according to the exemplary embodiment, in a state where the target vehicle deceleration and the vehicle state are constant, the target wheel deceleration of each of the wheels FR to RL does not change but the brake force of each of the wheels FR to RL, which is a control target, changes on the basis of the vehicle deceleration difference and the wheel deceleration difference. In other words, the brake ECU 6 changes the distribution of the brake force (target wheel brake force) to the wheels FR to RL on the basis of the wheel deceleration difference while keeping the distribution of the target wheel deceleration. Thereby, it is possible to achieve the distribution of the desired deceleration.

(Summarization)

Here, the control of the brake ECU 6 of the exemplary embodiment is summarized. In the exemplary embodiment, the second setting unit 66 is configured to set a target wheel deceleration to each of a first wheel and a second wheel of the vehicle, and the correction unit 69 is configured to correct the target wheel brake force corresponding to at least one of the first wheel and the second wheel (to set a corrected wheel brake force to at least one of the first wheel and the second wheel), based on the wheel deceleration difference of the first wheel and the wheel deceleration difference of the second wheel. Also, the brake device 100 for a vehicle according to the exemplary embodiment includes the state determination unit 62 configured to determine a turning state of the vehicle, and the correction unit 69 is configured to correct the target wheel brake force corresponding to at least one of the first wheel and the second wheel, based on a determination result of the state determination unit 62. Also, in the exemplary embodiment, the correction unit 69 is configured to correct the target wheel brake force corresponding to at least one of the first wheel and the second wheel, based on arrangement of the first wheel and the second wheel with respect to a turning direction of the vehicle.

Also, in the exemplary embodiment, the correction unit 69 is configured to compare the wheel deceleration difference of the first wheel and the wheel deceleration difference of the second wheel, and to set the corrected wheel brake force so that a correction amount to the target wheel brake force of the first wheel or the second wheel, which is a wheel having the larger wheel deceleration difference, is to be larger than a correction amount to the target wheel brake force of the first wheel or the second wheel, which is a wheel having the smaller wheel deceleration difference. A magnitude of the correction amount corresponds to a magnitude of the wheel deceleration difference. The correction unit 69 is configured to set the correction amount larger when the wheel deceleration difference of the correction target wheel is larger, for example. In this way, the correction unit 69 is configured to correct the target wheel brake force for at least one of the wheels FR to RL to which the target wheel deceleration is set so that the vehicle deceleration difference and the wheel deceleration difference of at least one of the wheels are to be smaller, based on the vehicle deceleration difference and the wheel deceleration difference.

Also, the distribution setting unit 63 may be configured to store the wheel (correction target wheel) to which the corrected wheel brake force is set, and to change a distribution of the brake force to be applied to the correction target wheel in a next brake operation and thereafter (one brake operation is after the driver starts a brake operation until the driver releases the same). According to this configuration, even when a regular variation occurs, it is possible to set the distribution, in a next brake operation and thereafter, considering the variation.

(Others)

The present invention is not limited to the exemplary embodiment. For example, the vehicle to which the brake device 100 for a vehicle is mounted may be a hybrid vehicle, an electric vehicle or a fuel cell vehicle having a regenerative braking device. Also, when the brake device 100 for a vehicle includes a pressure sensor configured to measure a wheel pressure, a detection value of the pressure sensor may be used instead of the estimated wheel pressure. Also, the present invention is suitable for an automatic driving vehicle, too. In the automatic driving vehicle, a frequency of maintenance to be performed by the driver may be reduced, and according to the present invention, it is possible to absorb the resultant variation, too. Also, in a case where the wheel deceleration difference is calculated for one wheel, when the vehicle deceleration difference is outside an allowable range and the wheel deceleration difference is within an allowable range, the target wheel brake force of the wheel for which the wheel deceleration difference has not been calculated may be corrected so that the vehicle deceleration difference is to be smaller. Also, the brake force may be referred to as brake torque. Also, as the diverse sensors configured to detect the turning state, sensors other than the above-described sensor may also be used.

1.-6. (canceled)

7. A brake device for a vehicle comprising:
a brake force applying unit configured to apply a brake force to at least one of wheels of the vehicle;
a first setting unit configured to set a target wheel brake force, which is a target brake force, to the at least one of wheels;
a control unit configured to control the brake force applying unit on the basis of the target wheel brake force;
a second setting unit configured to set a target wheel deceleration, which is a target deceleration, to the at least one of wheels to which the target wheel brake force is set;
a detection unit configured to detect an actual wheel deceleration, which is an actual deceleration of the wheel to which the target wheel deceleration is set;
a first calculation unit configured to calculate a vehicle deceleration difference, which is an absolute value of a difference between a target vehicle deceleration, which is a target deceleration of the vehicle, and an actual vehicle deceleration, which is an actual deceleration of the vehicle;
a second calculation unit configured to calculate a wheel deceleration difference, which is an absolute value of a difference between the target wheel deceleration and the actual wheel deceleration, for the wheel to which the target wheel deceleration is set; and
a correction unit configured to correct, on the basis of the vehicle deceleration difference and the wheel deceleration difference, the target wheel brake force corresponding to the at least one of wheels to which the target wheel brake force is set so that the vehicle deceleration difference is to be smaller.

8. The brake device for a vehicle according to claim 7, wherein
the second setting unit is configured to set the target wheel deceleration to each of a first wheel and a second wheel of the vehicle, and
the correction unit is configured to correct the target wheel brake force corresponding to at least one of the first wheel and the second wheel, based on the wheel deceleration difference of the first wheel and the wheel deceleration difference of the second wheel.

9. The brake device for a vehicle according to claim 8, further comprising:
a state determination unit configured to determine a turning state of the vehicle, wherein
the correction unit is configured to correct the target wheel brake force corresponding to at least one of the first wheel and the second wheel, based on a determination result of the state determination unit.

10. The brake device for a vehicle according to claim 9, wherein
the correction unit is configured to correct the target wheel brake force corresponding to at least one of the first wheel and the second wheel, based on arrangement of the first wheel and the second wheel with respect to a turning direction of the vehicle.

11. The brake device for a vehicle according to claim 8, wherein
the correction unit is configured to compare the wheel deceleration difference of the first wheel and the wheel deceleration difference of the second wheel, and to make such a setting that a correction amount to the target wheel brake force of the first wheel or the second wheel, which is a wheel having the larger wheel deceleration difference, is to be larger than a correction amount to the target wheel brake force of the first wheel or the second wheel, which is a wheel having the smaller wheel deceleration difference.

12. The brake device for a vehicle according to claim 7, wherein
the correction unit is configured to store a correction amount of the target wheel brake force corresponding to a correction target wheel, which is a correction target of the target wheel brake force, and to correct the target wheel brake force corresponding to the correction target wheel on the basis of the stored correction amount, in a next brake operation and thereafter.

13. The brake device for a vehicle according to claim 9, wherein
the correction unit is configured to compare the wheel deceleration difference of the first wheel and the wheel deceleration difference of the second wheel, and to make such a setting that a correction amount to the target wheel brake force of the first wheel or the second wheel, which is a wheel having the larger wheel deceleration difference, is to be larger than a correction amount to the target wheel brake force of the first wheel or the second wheel, which is a wheel having the smaller wheel deceleration difference.

14. The brake device for a vehicle according to claim 10, wherein
the correction unit is configured to compare the wheel deceleration difference of the first wheel and the wheel deceleration difference of the second wheel, and to make such a setting that a correction amount to the target wheel brake force of the first wheel or the second wheel, which is a wheel having the larger wheel deceleration difference, is to be larger than a correction amount to the target wheel brake force of the first wheel or the second wheel, which is a wheel having the smaller wheel deceleration difference.

15. The brake device for a vehicle according to claim 7, wherein
the correction unit is configured to store a correction amount of the target wheel brake force corresponding to a correction target wheel, which is a correction target of the target wheel brake force, and to correct the target wheel brake force corresponding to the correction target wheel on the basis of the stored correction amount, in a next brake operation and thereafter.

16. The brake device for a vehicle according to claim 8, wherein
the correction unit is configured to store a correction amount of the target wheel brake force corresponding to a correction target wheel, which is a correction target of the target wheel brake force, and to correct the target wheel brake force corresponding to the correction target wheel on the basis of the stored correction amount, in a next brake operation and thereafter.

17. The brake device for a vehicle according to claim 9, wherein
the correction unit is configured to store a correction amount of the target wheel brake force corresponding to a correction target wheel, which is a correction target of the target wheel brake force, and to correct the target wheel brake force corresponding to the correction target wheel on the basis of the stored correction amount, in a next brake operation and thereafter.

18. The brake device for a vehicle according to claim 10, wherein
the correction unit is configured to store a correction amount of the target wheel brake force corresponding to a correction target wheel, which is a correction target of the target wheel brake force, and to correct the target wheel brake force corresponding to the correction target wheel on the basis of the stored correction amount, in a next brake operation and thereafter.

19. The brake device for a vehicle according to claim 11, wherein
the correction unit is configured to store a correction amount of the target wheel brake force corresponding to a correction target wheel, which is a correction target of the target wheel brake force, and to correct the target wheel brake force corresponding to the correction target wheel on the basis of the stored correction amount, in a next brake operation and thereafter.

20. The brake device for a vehicle according to claim 12, wherein
the correction unit is configured to store a correction amount of the target wheel brake force corresponding to a correction target wheel, which is a correction target of the target wheel brake force, and to correct the target wheel brake force corresponding to the correction target wheel on the basis of the stored correction amount, in a next brake operation and thereafter.

21. The brake device for a vehicle according to claim 13, wherein
the correction unit is configured to store a correction amount of the target wheel brake force corresponding to a correction target wheel, which is a correction target of the target wheel brake force, and to correct the target wheel brake force corresponding to the correction target wheel on the basis of the stored correction amount, in a next brake operation and thereafter.
